(19) United States
(12) Patent Application Publication
(10) Pub. No.: US 2010/0254491 A1
(43) Pub. Date: Oct. 7, 2010

(54) DC OFFSET COMPENSATING SYSTEM AND METHOD

(75) Inventor: Richard Louis Zinser, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/416,188

(22) Filed: Apr. 1, 2009

(51) Int. Cl. H04L 25/06

(52) U.S. Cl. 375/319

(57) ABSTRACT

A system for removing a DC-offset component from an input signal is presented. The system includes a sorter to separate positive samples and negative samples of the input signal. The system further includes a positive sample average generator to calculate a positive sample average according to a number of positive samples in the input signal and a negative sample average generator to calculate a negative sample average according to a number of negative samples in the input signal. A balanced average generator is provided for receiving positive and negative sample averages from the positive and negative sample average generators and for generating a reference signal. The system further includes a subtractor for subtracting the reference signal from the input signal to generate a DC-offset compensated output signal.

### BACKGROUND

The subject matter disclosed herein relates to DC-offset compensation in digital receivers.

In digital communication systems, transmission signals are produced by the modulation of a carrier signal with digital data to be transmitted. The digital data is commonly transmitted in packets wherein each packet includes a number of data bits. After the transmitted signal is received, the signal requires demodulation in order to recover the data.

Radio receiver architectures commonly employ direct conversion receivers, such as homodyne receivers, to perform the demodulation of a received signal. A local oscillator operating at the carrier signal frequency is used to mix down the received signal to produce in-phase (I) and quadrature (Q) baseband signals. The direct conversion receiver converts the incoming carrier signal directly to baseband, in both I and Q components, without use of any intermediate frequencies. However, direct conversion receivers have some drawbacks. For example, a DC-offset can be introduced post-demodulation, due to a frequency offset between the transmitter and RX local oscillator. Additionally, in some systems the DC-offset component can be several decibels (dB) larger than the information signal, and thus DC-offset compensation is required for information signal recovery.

One way to compensate for DC-offset is to estimate the mean value of the received packet, subtract the estimate from the received signal, and then feed the signal to the decoder. However, the standard estimate of the mean value tends to introduce a bias in the calculated DC-offset if the number of transmitted ones and zeros are not equal in the data used for the estimate. The bias in the calculated DC-offset could be large enough to cause an increase the bit error rate of the receiver.

Therefore, there is a need for an enhanced method and system to remove DC-offset components.

### BRIEF DESCRIPTION

Briefly, a DC-offset component compensation system is presented. The system includes a sorter to separate positive samples and negative samples of the input signal. The system further includes a positive sample average generator for calculating a positive sample average according to a number of positive samples in the input signal and a negative sample average generator for calculating a negative sample average according to a number of negative samples in the input signal. A balanced average generator is provided for receiving positive and negative sample averages from the positive and negative sample average generators and for generating a reference signal. The system further includes a subtractor for subtracting the reference signal from the input signal to generate a DC-offset compensated output signal.

In one embodiment, a digital radio receiver system is provided. The digital radio receiver system includes a radio front end to receive a modulated signal, and a digital receiver module comprising an analog to digital converter to digitize the modulated signal and a digital down converter to convert the digitized modulated signal to a baseband signal. A baseband processor having a DC compensating module, a timing recovery module, a bit detector, and a frame synchronization module is provided. The baseband processor is configured to generate a demodulated DC-offset compensated output signal. The digital receiver module and the baseband processor are implemented on a digital processor. The DC compensating module implements a sorter to compute separate positive sample and negative sample averages and a balanced average generator to generate a DC-offset compensated output signal.

In one embodiment, a method for compensating a DC-offset in a digital receiver is presented. The method includes segregating a positive sample and a negative sample from an input signal and computing autoregressive averages of the positive samples and the negative samples. The method further includes adding the averages of the positive samples and the negative samples, calculating a balanced average of the added averages, subtracting the balanced average from the input signal, and generating a DC-offset compensated output signal from the subtraction.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary digital radio receiver;

FIG. 2 is a block diagram of a base-band processor in accordance with an embodiment as implemented in the system of FIG. 1;

FIG. 3 is a block diagram of a DC compensating system implementing a balanced average generator in accordance with an embodiment described herein;

FIG. 4 illustrates a block diagram of a DC compensating system implementing an autoregressive average generator in accordance with an embodiment described herein; and

FIG. 5 illustrates a block diagram of a DC compensating system implementing a fixed point autoregressive average generator in accordance with an embodiment described herein.

### DETAILED DESCRIPTION

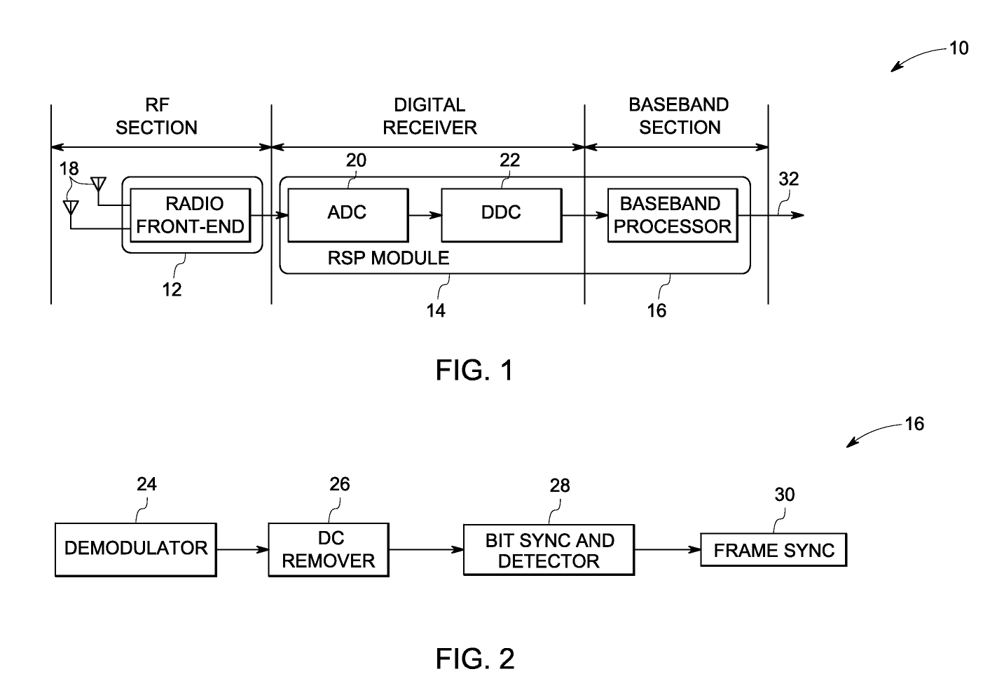

FIG. 1 is a block diagram of an exemplary digital radio receiver 10. Digital radio receiver 10 includes a radio front-end module 12, a digital receiver module 14, and a base-band processor 16. Radio front-end module 12 receives a radio signal and base-band processor 16 generates a de-modulated digital output signal 32.

Radio front-end module 12 is configured to amplify signals received from an antenna 18. Digital receiver module 14 includes an analog to digital converter 20 to convert the signals from radio front-end module 20 to digital signals. Digital receiver module 14 further includes a digital down converter 22 (DDC) to convert a digitized signal centered at a carrier frequency to a base-band signal centered at zero frequency. In addition to down conversion, DDCs typically decimate to a lower sampling rate, allowing further signal processing by lower speed processors.

FIG. 2 is a block diagram of base-band processor 16 of FIG. 1. Base-band processor 16 includes a demodulator 24, a DC compensating module 26, a bit synchronization and detector unit 28, and a frame synchronization module 30. In a presently contemplated embodiment, base-band processor 16 may be implemented on any digital processing platform. Non-limiting examples of digital processing platforms include Digital Signal Processing (DSP) chips, Field Programmable Gate Arrays, or Application-specific integrated circuits (ASIC). Demodulator 24 may be configured to convert frequency variations in the input signal to a base-band waveform whose amplitude may be proportional to the input signal frequency. DC compensating module 26 is configured for removing DC-offset in the demodulated signal. Bit synchronization and detector 28 and frame synchronization module 30 are configured to recover the bit timing information in order to minimize the length of the header and to determine the location of a demarcated position within a received bit stream signal.

Traditional DC compensation techniques include simple averaging techniques. In binary digital receivers employing non-return-to-zero (NRZ) modulating waveforms, such detection techniques include polarity comparisons. In such techniques, a positive binary 1 may be detected when the demodulated waveform is greater than zero (e.g. a positive voltage), and a negative binary 0 may be detected when the demodulated waveform is less than zero (e.g. a negative voltage). However, the zero (or DC) level may drift with respect to a fixed external reference, giving rise to a DC-offset. A simple average of the detected waveform, as used in the art, can be biased if the number of transmitted 1s and 0s is not equal over a short duration resulting in incorrect DC compensation. Such DC-offset in the signal may degrade the receiver bit error performance along with the presence of noise. Embodiments described herein use balanced averaging to overcome such shortcomings discussed above.

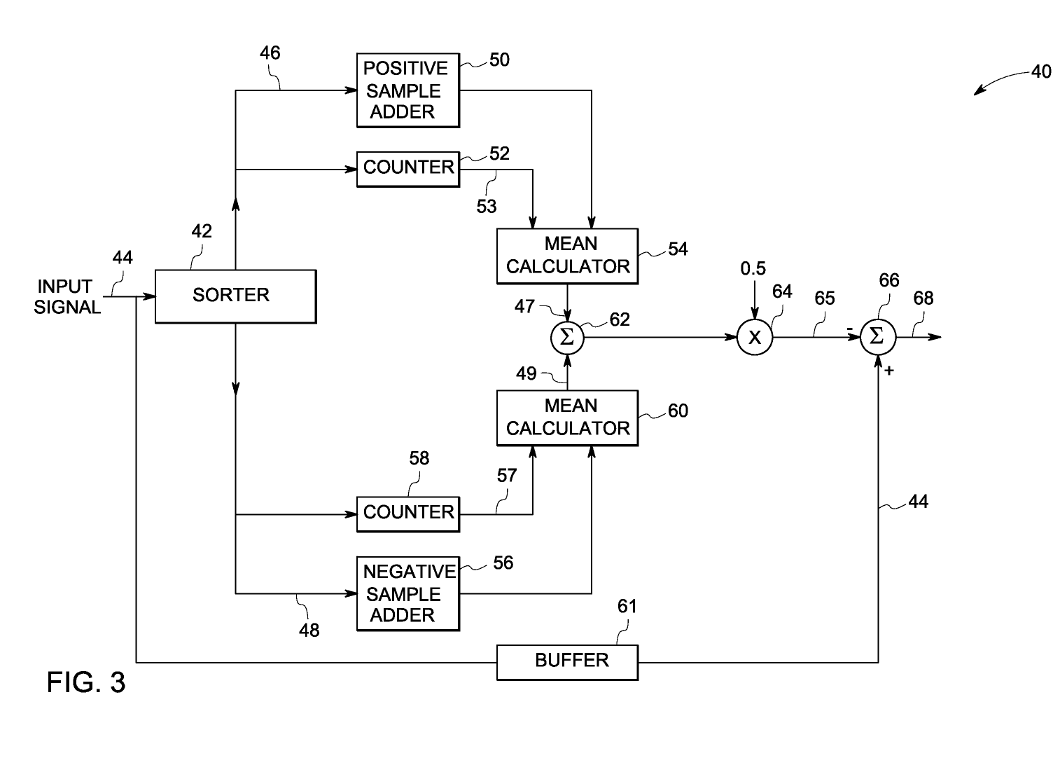

FIG. 3 is a block diagram of a DC compensating system 40 implementing a balanced average generator according to an aspect of the invention. The exemplary DC compensating system 40 includes a sorter 42 to separate positive samples 46 and negative samples 48 of an input signal 44. The input signal 44 may include a stream of data bits having multiple samples per symbol. In the embodiment of FIG. 3, a positive sample average generator is coupled to sorter 42 and comprises a positive sample adder 50, a counter 52, and a divider 54. Further, a negative sample average generator is coupled to sorter 42 and comprises a negative sample adder 56, a counter 58, and a divider 60. The output of the positive sample average generator (a positive sample average 47) and the negative sample average generator (a negative sample average 49) are received by a balanced average generator for generating a reference signal. In one embodiment, the balanced average generator comprises a summation element 62 and a mean element 64 for generating a balanced average from the summed up positive and negative sample averages. A subtractor 66 is coupled to the balanced average generator and receives the input signal through an input signal buffer 61. A bit detector (not shown) coupled to subtractor 66 may be configured to process an output signal 68 from subtractor 66.

In one example of operation, the sorter 42 receives demodulated input signal 44 and segregates the positive samples 46 and the negative samples 48 from the input signal 44. The input signal 44 is also buffered during these operations into the input signal buffer 61. Input signal buffer 61, for example, may include a first in first out (FIFO) memory. Divider 54 computes the positive sample average 47 by way of dividing the added positive samples (from positive sample adder 50) with the number of positive samples 53 stored in counter 52. Similarly, divider 60 computes the negative sample average 49 by way of dividing the added negative samples (from negative sample adder 56) with the number of negative samples 57 stored in counter 58. The mean generator is configured to generate a reference signal 65 by multiplying a fraction (for example 0.5) by the summed up positive and negative sample averages from summer 62. Subtractor 66 is configured for subtracting the reference signal 65 from the input signal 44 (from the input signal buffer 61) to generate a DC-offset compensated output signal 68. A bit detector may be configured to receive such output signal 68 to detect positive binary 1 when the output signal 68 is greater than zero (e.g. a positive voltage). Further, a negative binary 0 may be detected when the output signal 68 is less than zero (e.g. a negative voltage).

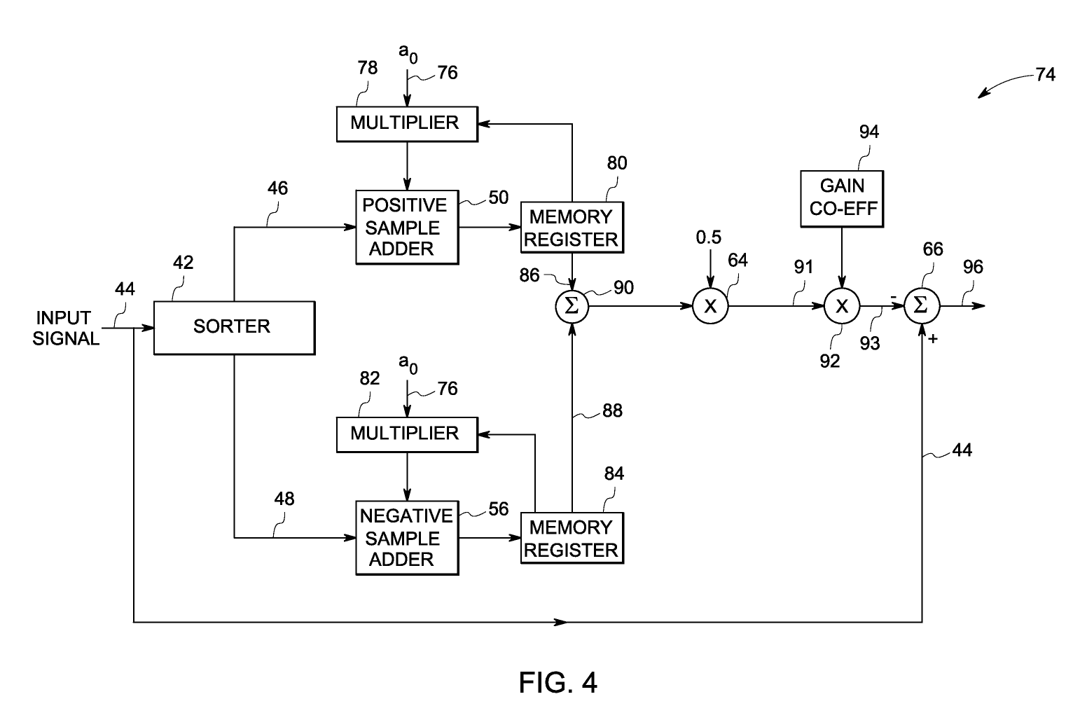

FIG. 4 is a block diagram of a DC compensating system 74 implementing an autoregressive average generator according to an aspect of the invention. The exemplary DC compensating system 74 includes a sorter 42 to separate positive samples 46 and negative samples 48 of the input signal 44. A positive sample average generator comprises a first autoregressive (AR) averaging loop, wherein the first autoregressive (AR) averaging loop includes a multiplier 78 (using a autoregressive co-efficient 76), and a positive memory register 80 coupled to a positive sample adder 50. The exemplary DC compensating system 74 further includes a negative sample average generator including a second autoregressive (AR) averaging loop, wherein the second autoregressive (AR) averaging loop includes a multiplier 82 (using the autoregressive co-efficient of the first AR averaging loop), and a negative memory register 84 coupled to a negative sample adder 56. The output of the first AR averaging loop (a autoregressive positive sample average 86) and the second AR averaging loop (a autoregressive negative sample average 88) are added at an adder 90. A balanced average generator (represented by summation element 90 and mean element 64) generates a balanced average 91 of the summed up positive and negative sample averages. A gain multiplier 92 is configured to normalize the balanced averages 91. A subtractor 66 (configured to generate an output signal 96) is coupled to the gain multiplier 92 and input signal 44.

During an operation of the DC compensating system 74, input signal 44 is sorted out, one sample at a time, into positive samples 46 and negative samples 48 by sorter 42 depending on the polarity of the sample. An autoregressive averaging is performed by the first autoregressive loop and the second autoregressive loop. The first autoregressive loop adds the sorted positive sample 46 to the autoregressive coefficient-scaled contents of memory register 80 at the positive sample adder 50. The operation is performed for every new incoming positive sample from sorter 42.

It may be noted that the loop calculations are performed according to corresponding polarity of the sample. For example, only one of the two loops is active for a given input sample, wherein the first autoregressive loop is for positive samples and the second autoregressive loop for negative samples. In an exemplary embodiment, if a positive sample is detected, then the first autoregressive loop is in operation updating the value in positive memory register 80. The second autoregressive loop remains idle, and the value of negative memory register 84 remains unchanged. Similarly if a negative sample is detected, then the second autoregressive loop is in operation, updating the value in the negative memory register 84. The first autoregressive loop remains idle, and the value of positive memory register 80 remains unchanged. Further, the two loops include multiplying the stored samples (in memory registers 80, 84) with an autoregressive co-efficient 76 at the multipliers 78 and 82 respectively for the positive samples and the negative samples.

For each input sample of either polarity (positive or negative) autoregressive positive sample average 86 and autoregressive negative sample average 88 are summed up at adder 90 and multiplied by a fraction, for example 0.5, within the balance average generator. Gain multiplier 92 is coupled to the balance average generator and multiplies the balanced averages 91 with the gain co-efficient 94 (which is one minus the autoregressive co-efficient 76) to generate a normalized balanced average 93. Subtractor 66 is configured to subtract normalized balanced average 93 from input signal 44 to generate the DC-offset compensated output signal. A bit detector (not shown) may be coupled to subtractor 66 for further processing of the output signal 96 as discussed earlier.

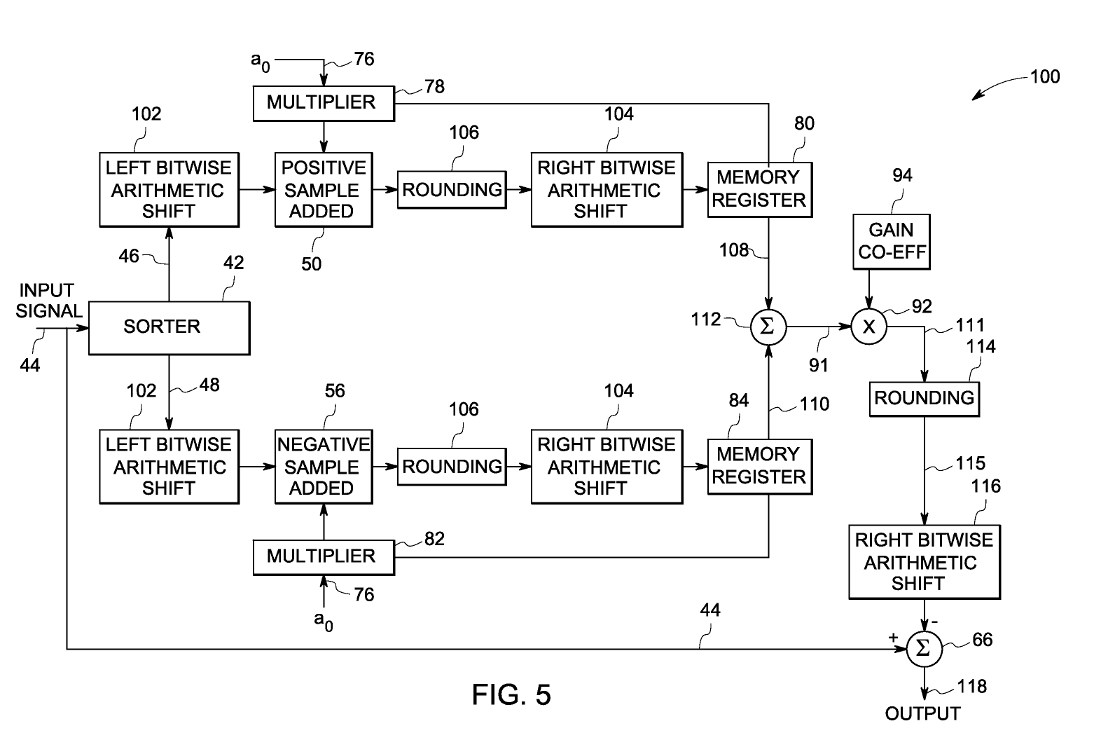

FIG. 5 is a block diagram of a DC compensating system 100 implementing a fixed point autoregressive average generator according to an aspect of the invention. The exemplary DC compensating system 100 includes a sorter 42 to separate positive samples 46 and negative samples 48 of the input signal 44. A positive sample average generator comprises a first fixed point autoregressive (AR) averaging loop, wherein the first fixed point autoregressive (AR) averaging loop includes a multiplier 78 (using a autoregressive co-efficient 76), a left bitwise arithmetic shifter 102, right bitwise arithmetic shifter 104, a rounding block 106, and a positive memory register 80. The exemplary DC compensating system 100 further includes a negative sample average generator that comprises a second fixed point autoregressive (AR) averaging loop, wherein the second fixed point autoregressive (AR) averaging loop includes a multiplier 82 (using the autoregressive co-efficient 76 of the first fixed point autoregressive averaging loop), a left bitwise arithmetic shifter 102, right bitwise arithmetic shifter 106, a rounding block 106, and a negative memory register 84.

The output of the first fixed AR averaging loop (a fixed point autoregressive positive sample average 108) and the second AR averaging loop (a fixed point autoregressive negative sample average 110) are added at an adder 112. A gain multiplier 92 coupled to a gain co-efficient 94 is configured to normalize the balanced averages 91. A rounding block 114 and a right bitwise arithmetic shifter 116 are coupled to the gain multiplier 92. A subtractor 66 configured to generate an output signal 118 is coupled to the right bitwise arithmetic shifter 116 and the input signal 44.

In one example of operation of the DC compensating system 100 implementing a fixed point autoregressive average generator, multiple bits (or samples) of input signal 44 are sorted, one sample at a time, into positive samples 46 and negative samples 48 by sorter 42 depending on the polarity of the sample. A fixed point autoregressive averaging is performed by the first fixed point autoregressive loop and the second fixed point autoregressive loop. The first fixed point autoregressive loop performs a bitwise left shift at arithmetic shifter 102. The left shifted samples are summed with the autoregressive coefficient-scaled contents of register 80 at the positive sample adder 50. The added positive samples are rounded in a rounding module 106, and then right shifted at right bitwise arithmetic shifter 104. Right shifted samples are stored in positive memory register 80. The operation is performed for every new incoming positive sample from sorter 42.

It may be noted that the loop calculations are only performed when a sample of the correct polarity is present. For example, only one of the two loops is active for a given input sample, wherein the first fixed point autoregressive loop is for positive samples and the second fixed point autoregressive loop for negative samples. In an exemplary embodiment, if a positive sample is detected, then the first fixed point autoregressive loop is in operation updating the value in positive memory register 80. The second fixed point autoregressive loop remains idle, and the value of negative memory register 84 remains unchanged. Similarly if a negative sample is detected, then the second fixed point autoregressive loop is in operation, updating the value in negative memory register 84. The first fixed point autoregressive loop remains idle, and the value of positive memory register 80 remains unchanged. Further, the two loops include multiplying the stored samples (in memory registers 80, 84) with an autoregressive co-efficient 76 at the multipliers 78 and 82 respectively for the positive samples and the negative samples.

For each input sample of either polarity (positive or negative), fixed point autoregressive positive sample average 108 and fixed point autoregressive negative sample average 110 are summed up at adder 112 and multiplied by the gain co-efficient 94 at the gain multiplier 92 coupled to the summer 112. Normalized signal 111 from adder 112 is rounded in a rounding block 114. A rounded sample 115 is obtained by right shifting samples bitwise at the arithmetic shifter 116. Subtractor 66 is configured to subtract the shifted samples 115 from input signal 44 to generate the DC-offset compensated output signal 118. A bit detector may be coupled to subtractor 66 for further processing the output signal 118 as discussed earlier.

Advantageously, various embodiments of the invention, when implemented within DC compensating systems eliminates the need for “spectral whitening” at the transmitter and makes the receiver much more versatile when dealing with long runs of 1s or 0s. Further, for receivers designed for frequency modulated (FM) signals, embodiments of the invention help in mitigating the effects of frequency mismatch that may bias the output signal such that there are no zero crossings, resulting in effective non-return-to-zero detection and synchronization.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A DC-offset component compensation system comprising:
a sorter to separate positive samples and negative samples of the input signal;
a positive sample average generator to calculate a positive sample average according to a number of positive samples in the input signal;
a negative sample average generator to calculate a negative sample average according to a number of negative samples in the input signal;
a balanced average generator for receiving positive and negative sample averages from the positive and negative sample average generators and for generating a reference signal;
a subtractor for subtracting the reference signal from the input signal to generate a DC-offset compensated output signal.

2. The system of claim 1, wherein the positive sample average generator comprises a counter to count a number of the positive samples, a positive sample adder to sum the values of the positive samples, and a divider to divide the sum by the number to generate the positive sample average, and
wherein the negative sample average generator comprises a counter to count a number of the negative samples, a negative sample adder to sum the values of the negative samples, and a divider to divide the sum by the number to generate the negative sample average.

3. The system of claim 1, wherein the positive sample average generator comprises a first autoregressive (AR) averaging loop having an autoregressive co-efficient and for receiving the positive samples, wherein the negative sample average generator comprises a second autoregressive (AR) averaging loop having the autoregressive co-efficient and for receiving the negative samples.

4. The system of claim 3, wherein the balanced average generator comprises a summation element for adding the output signals of the first and second AR averaging loops and a mean element for averaging the summed output signals.

5. The system of claim 3 further comprising a multiplier for multiplying the averaged output signals by a gain co-efficient.

6. The system of claim 4, wherein each of the first and second autoregressive (AR) averaging loops comprises a memory register to store the respective positive or negative samples.

7. The system of claim 6, wherein each respective autoregressive (AR) averaging loop further comprises a multiplier to multiply the autoregressive co-efficient and autoregressive coefficient-scaled contents of the respective memory register.

8. The system of claim 1, wherein the positive sample average generator comprises a first fixed point autoregressive (AR) averaging loop having a autoregressive co-efficient and for receiving the positive samples, and
wherein the negative sample average generator comprises a second fixed point autoregressive (AR) averaging loop having the autoregressive coefficient and for receiving the negative samples.

9. The system of claim 8, wherein the balanced average generator comprises a summation element for adding the output signals of the first and second fixed point AR averaging loops, and averaging the summed output signals.

10. The system of claim 9 further comprises multiplying the averaged output signals by the gain co-efficient.

11. The system of claim 9, wherein the first and second fixed point AR averaging loops further comprise left and right bitwise arithmetic shifters and rounding blocks.

12. A digital radio receiver system comprising:
a radio front end to receive a modulated signal;
a digital receiver module comprising an analog to digital converter to digitize the modulated signal and a digital down converter to convert the digitized modulated signal to a baseband signal;
a baseband processor comprising a DC compensating module, a bit detector and synchronization module, and a frame synchronization module, wherein the baseband processor is configured to generate a DC-offset compensated demodulated output signal representing an unbiased estimate of the input signal average;
wherein the digital receiver module and the baseband processor are implemented on a digital processor; and
wherein the DC compensating module implements a sorter to compute separate positive sample and negative sample averages and a balanced average generator to generate a DC-offset compensated output signal.

13. The system of claim 12, wherein the DC compensating module further comprise a positive sample average generator comprising a first autoregressive (AR) averaging loop having a autoregressive coefficient and for receiving the positive samples; and a negative sample average generator comprising a second autoregressive (AR) averaging loop having the autoregressive coefficient and for receiving the negative samples.

14. The system of claim 13, wherein the balanced average generator comprises a summation element for adding the output signals of the first and second AR averaging loops, a mean element for averaging the summed output signals, and a gain multiplier for multiplying the averaged output signals by the gain coefficient.

15. A method for compensating a DC-offset in a digital receiver, the method comprising:
segregating positive samples and negative samples from an input signal;
computing autoregressive averages of the positive samples and the negative samples;
adding the averages of the positive samples and the negative samples;
calculating a balanced average of the added averages;
subtracting the balanced average from the input signal; and
generating a DC-offset compensated output signal from the subtraction.

16. The method of claim 15, wherein computing the averages comprises using fixed point autoregressive averages.

17. The method of claim 16, wherein using fixed point autoregressive averages comprises left and right bitwise arithmetic shifting the samples.
